(19) United States
(12) Patent Application Publication
(10) Pub. No.: US 2013/0143079 A1
(43) Pub. Date: Jun. 6, 2013

(54) BATTERY SYSTEM WITH HEAT-DISSIPATION IMPROVEMENT AND CONNECTING CIRCUIT ARRANGEMENT

(71) Applicants: JEN-CHIN HUANG, NEW TAIPEI CITY (TW); HUABIN SONG, CHANGSHU CITY (CN)

(72) Inventors: JEN-CHIN HUANG, NEW TAIPEI CITY (TW); HUABIN SONG, CHANGSHU CITY (CN)

(73) Assignees: GOLDEN CROWN NEW ENERGY (HK) LIMITED, HONGKONG (HK); SUZHOU GOLDEN CROWN NEW ENERGY CO., LTD., CHANGSHU CITY (CN)

(21) Appl. No.: 13/362,984

(22) Filed: Jan. 31, 2012

(30) Foreign Application Priority Data
Dec. 2, 2011 (CN) 201110395163.0
Dec. 2, 2011 (CN) 201110395168.3
Dec. 2, 2011 (CN) 201110395192.7

(51) Int. Cl. H01M 10/48; H01M 10/42; H01M 10/50; H01M 2/10

(52) U.S. Cl. 429/61; 429/99; 429/90

(57) ABSTRACT

A battery system includes a battery module, a frame for receiving the battery module, a cover covering the frame, a heat sink, a battery management circuit board and a battery balancing circuit board. The battery module includes a bracket assembly and a number of batteries fixed to the bracket assembly. The batteries are electrically connected to each other. The battery management circuit board is fixed to the bracket assembly and electrically connected to the batteries. The battery management circuit board is separated by a distance from the bracket assembly. The battery balancing circuit board is fixed to the heat sink and includes a battery balancing control module for controlling surplus electric energy of the batteries dissipated into thermal energy.

### CROSS-REFERENCE TO RELATED APPLICATIONS

This application claims priority to and the benefit of, pursuant to 35 U.S.C. §119(a), Chinese patent application Nos. 201110395168.3, 201110395163.0, and 201110395192.7, all filed Dec. 2, 2011. The disclosure of each of the above-identified Chinese patent applications is incorporated herein by reference in its entirety.

This application is related to a co-pending U.S. patent application Ser. No. 13/360,468, entitled “BATTERY MODULE AND BRACKET ASSEMBLY THEREOF FOR POSITIONING BATTERIES”. The co-pending application was filed on filed Jan. 27, 2012, with the same inventors and the same assignee as that of this application. The disclosure of the co-pending application is incorporated herein by reference in its entirety.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to a battery system, and more particularly to a battery system with improved heat-dissipation capability, and convenient connecting circuit arrangement and good reparability.

### BACKGROUND OF THE INVENTION

Nowadays, considering the environment pollution becomes more and more serious, storage batteries, because of their charging and discharging capabilities, are widely used as power sources to replace the conventional fossil fuels for solving the environmental problems. In the field of vehicle powers, comparing with the conventional power sources, electrical power sources have obvious advantages in environment protection. Battery is a kind of perfect electrical power sources because of no gasoline consumption, no exhaust gas, low noise and small radiation. Presently, ordinary electrical power sources are combined by placing multiple batteries into a battery bracket, and then the batteries are linked in parallel connection and/or in series connection so as to form a battery module for providing power source.

Usually, the battery module is placed into a frame to form a battery system. Besides, the battery system further includes a multiple circuits provided by a plurality of circuit boards. It is well known that a large amount of heat may be generated when the circuits of the battery system are working In particular, regarding a passive balance circuit, because there is a need to transform surplus electric energy of the batteries into thermal energy, a large amount of heat ineluctably is generated, which may damage the circuit boards if such heat can not be dissipated to the outside in time. Besides, the circuit boards include a battery management circuit board for controlling charging and discharging of the batteries. In current designs, the battery management circuit board is usually mounted on a cover of the battery system and connecting with the batteries via connecting lines. However, in such an arrangement, connecting circuits may be complicated for collocation and it is inconvenience for opening to repair the cover.

Therefore, an improved battery system with improved heat-dissipation capability and with convenient connecting circuit arrangement and good reparability is desired.

### SUMMARY OF THE INVENTION

The present invention provides a battery system including a battery module, a frame defining a receiving cavity for accommodating the battery module, a cover for covering the frame, a heat sink, a battery management circuit board and a battery balancing circuit board for controlling the batteries. The battery module includes a bracket assembly and a plurality of batteries fixed to the bracket assembly with the batteries electrically connecting with each other. The battery management circuit board is fixed to the bracket assembly and electrically connects with the batteries. The battery management circuit board is separated by a distance from the bracket assembly so that it is easy to arrange the connecting circuits and easy to open the cover for repairing. The battery balancing circuit board is fixed to the heat sink and includes a battery balancing control module for controlling surplus electric energy of the batteries dissipated into thermal energy. As a result, the generated heat of the battery balancing circuit board is dissipated to the outside timely.

The foregoing disclosure has outlined rather broadly the features and technical advantages of the present invention in order that the detailed description of the invention that follows may be better understood. Additional features and advantages of the invention will be described hereinafter which form the subject of the claims of the invention.

In one aspect of the present invention, a battery system includes a battery module, a frame, a cover and a battery management circuit board. The battery module includes a bracket assembly and a plurality of batteries fixed to the bracket assembly, where the batteries are electrically connected to each other. The frame defines a receiving cavity for accommodating the battery module. The cover covers the frame. The battery management circuit board is fixed to the bracket assembly and electrically connected to the batteries, and the battery management circuit board is separated by a distance from the bracket assembly.

In one embodiment, the battery system further includes a supporting post located between the battery management circuit board and the bracket assembly. The battery management circuit board is supported by the supporting post. In another embodiment, the bracket assembly includes a top bracket and a bottom bracket with the batteries clamped therebetween. The top bracket includes a top wall and a mounting post extending from the top wall such that the mounting post is fixed to the supporting post via thread connection. The battery management circuit board is separated from the top wall of the bracket assembly by the supporting post and the mounting post.

In one embodiment, the battery system further includes a heat sink located between the battery management circuit board and the cover, where the heat sink is connected to the battery management circuit board through a fixing post. The supporting post may be longer than the fixing post. Further, the heat sink can be made of metal and defines a recessed area to receive the battery balancing circuit board. In addition, the heat sink is stamped to form a protrusion with the recessed area defined therein. The cover defines an opening through which the protrusion is exposed.

In another embodiment, the battery system further includes a battery balancing circuit board between the battery management circuit board and the heat sink, where the battery balancing circuit board is adapted for controlling surplus electric energy of the batteries being dissipated into thermal energy.

In one embodiment, the battery management circuit board includes a battery management control module for surveilling voltage, current and temperature of the batteries. In another embodiment, the battery management control module comprises an electric switch, and the battery management control module realizes protecting the batteries via controlling connection or disconnection of the electric switch.

In another aspect of the present invention, a battery system includes a battery module, a frame, a cover, a heat sink and a battery balancing circuit board. The battery module includes a bracket assembly and a plurality of batteries fixed to the bracket assembly, where the batteries are electrically connected to each other. The frame defines a receiving cavity for accommodating the battery module. The cover covers the frame. The heat sink is fixed between the frame and the cover. The battery balancing circuit board is fixed to the heat sink and has a battery balancing control module for controlling surplus electric energy of the batteries being dissipated into thermal energy.

In one embodiment, the battery system further includes a battery management circuit board comprising a battery management control module for surveilling voltage, current and temperature of the batteries. In one embodiment, the battery management control module includes an electric switch, where the battery management control module is adapted for protecting the batteries via controlling connection or disconnection of the electric switch. The electric switch may include a field effect transistor.

In another embodiment, the battery system further includes an insulating piece located between the electric switch and the heat sink. A projected area of the insulating piece on the heat sink may be larger than that of the electric switch on the heat sink in order to prevent the electric switch from electrically contacting the heat sink. In yet another embodiment, the battery system further includes heat-dissipating oil filled between the electric switch and the insulating piece, and between the insulating piece and the heat sink. The insulating piece may include silicone or mica insulator, and the heat-dissipating oil may include heat-dissipating silicone.

In one embodiment, the heat sink is made of metal and stamped to form a protrusion with a recessed area defined therein, such that the battery balancing circuit board is received in the recessed area. Further, the cover may define an opening to receive the protrusion of the heat sink. The battery system may further include cooling fins for covering the opening and in communication with the heat sink.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 is a perspective view of a battery system with a plurality of batteries linked in parallel connection in accordance with one embodiment of the present invention;

FIG. 2 is a perspective view of a battery system with a plurality of batteries linked in series connection in accordance with another embodiment of the present invention;

FIG. 3 is a perspective view of a battery module with a plurality of batteries jointed together and fixed by a bracket assembly in accordance with one embodiment of the present invention;

FIG. 4 is a perspective view of a frame of a battery system for receiving the battery module in accordance with one embodiment of the present invention;

FIG. 5 is a perspective view of a cover of a battery system in accordance with one embodiment of the present invention;

FIG. 6 is a partial assembly view of a battery system showing a battery management circuit board assembled together with part of the frame assembly in accordance with one embodiment of the present invention;

FIG. 7 is an exploded view of a battery system showing the battery management circuit board and its related components in accordance with one embodiment of the present invention;

FIG. 8 is a perspective view of a heat sink as shown in FIG. 6;

FIG. 9 is a perspective view of a heat sink in accordance with one embodiment of the present invention;

FIG. 10 is a perspective view of a cooling fins of a battery system in accordance with one embodiment of the present invention; and

FIG. 11 is a perspective view of an assembled battery system in accordance with one embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

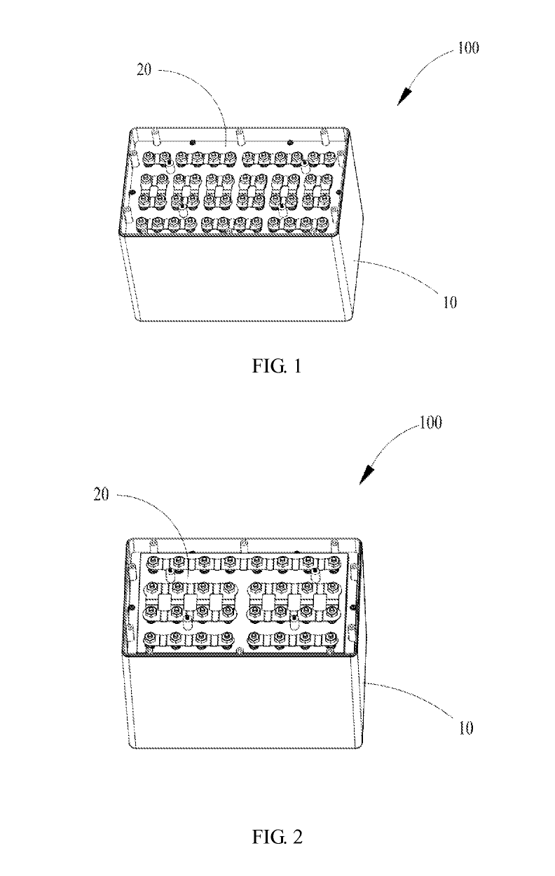

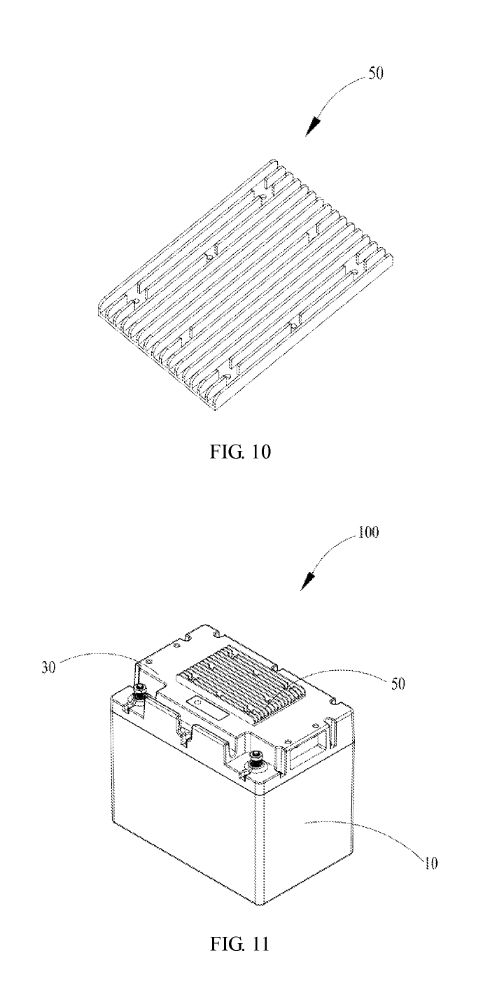

The description will be made as to the embodiments of the present invention in conjunction with the accompanying drawings in FIGS. 1-11. In accordance with the purposes of this invention, as embodied and broadly described herein, this invention, in one aspect, relates to a battery system with improved heat-dissipation capability, and convenient connecting circuit arrangement and good reparability.

Reference will be made to the drawing figures to describe the present invention in detail, wherein depicted elements are not necessarily shown to scale and wherein like or similar elements are designated by same or similar reference numeral through the several views and same or similar terminology.

Referring to FIGS. 1-5, 7 and 11, a battery system 100 is shown according to one embodiment of the present invention. The battery system 100 includes a frame 10, a battery module 20 received in the frame 10, a cover 30 covering the frame 10, a battery management circuit board 41 fixed to battery module 20, a heat sink 42 fixed between the frame 10 and the cover 30, a battery balancing circuit board 43 fixed to the heat sink 42, and a cooling fins 50 mounted on the cover 30.

Referring to FIGS. 1, 2 and 4, and particularly to FIG. 4, the frame 10 is box-shaped and defines a receiving cavity (not labeled) through its top side for receiving the battery module 20. The frame 10 includes a bottom wall (not labeled) and four side walls 11 extending upwardly from the bottom wall to form the receiving cavity. Each side wall 11 includes a plurality of positioning ribs 12 extending along a vertical direction and exposed to the receiving cavity for positioning the battery module 20. Besides, each rib 12 defines a threaded hole at its top. The threaded holes cooperating with screws are adapted for not only fixing the battery module 20 to the frame 10, but also fixing the cover 30 to the frame 10. In the exemplary embodiment, the frame 10 is made of an insulative material, such as ABS plastic, for isolating batteries. According to the embodiment, the frame 10 is square from a top view. However, the frame 10 can be formed in any types of shapes to meet the configuration of the battery module 20.

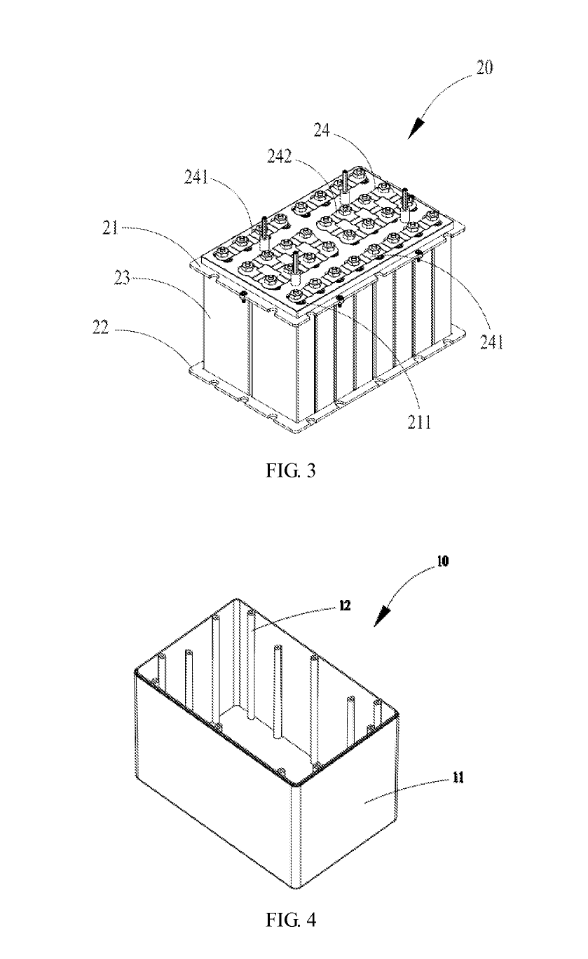

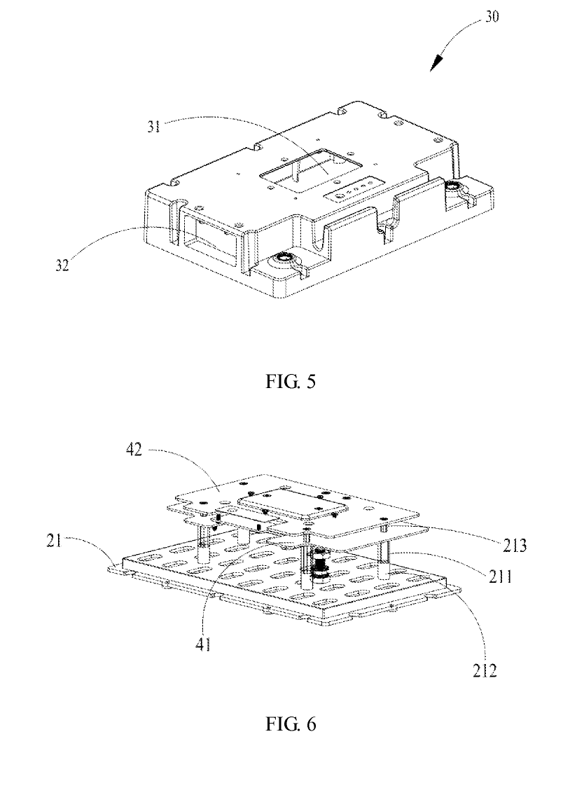

Referring to FIGS. 3 and 6 now, the battery module 20 includes a bracket assembly, a plurality of batteries 23 fixed to the bracket assembly and a plurality of conductive members 24 for electrically and mechanically linking the batteries 23 in parallel connection and/or in series connection. The bracket assembly includes a top bracket 21 and a bottom bracket 22 opposite to the top bracket 21 for jointly clamping the batteries 23 along the vertical direction. Besides, in order to fasten the batteries 23 more stably, adhesive members, such as glass cement or double-face adhesive tapes, are applied between the frame 10 and the batteries 23.

The top bracket 21 includes a top wall defining a plurality of holes through which the positive poles and the negative poles upwardly extend, and a plurality of a mounting posts 212 extending upwardly from the top wall. Further, the top bracket 21 includes a plurality of peripheral top flanges that define a plurality of top cutouts spatially separated from each other.

The bottom bracket 22 includes a plurality of bottom flanges which define a plurality of bottom cutouts separated from each other. The corresponding top and bottom cutouts are aligned with each other along the vertical direction for receiving the ribs 12 when the battery module 20 is installed in the frame 10. Under the guiding of cutouts and the ribs 12, the battery module 20 can be easily installed in the frame 10 with precise positioning. As a result, the battery module 20 is firmly fixed therein and may not be easily be disengaged with the fame 10 even if the battery module 20 is in actual working circumstances of shaking or bumping.

Each battery 23 includes a pair of positive pole and negative pole respectively electrically connecting anode and cathode inside of the battery. The batteries 23 can be selectively configured in different kinds of specifications including battery voltages and battery capabilities. Usually, a plurality of the batteries 23 in the same specification is required to have the same rated voltage and the same rated capability to assure a precise configuration and meet modeling requirements. However, various specifications of the batteries 23 may be achieved via altering electrically linking means thereof. For example, in a first embodiment, the number of the batteries 23 is twenty-four and each battery 23 has a rated voltage of 3V and a rated capability of 12.5 AH. Linking all of the twenty-four batteries 23 in series connection can achieve a specification of 72V and 12.5 AH. Alternatively, as shown in FIG. 1, the twenty-four batteries 23 can be linked in pairs in parallel connection first, and then linked in series connection to achieve a specification of 36V and 25 AH.

In another embodiment, the number of the batteries 23 is sixteen and each battery 23 has a rated voltage of 3V and a rated capability of 25 AH. Linking all the sixteen batteries 23 in series connection can achieve a specification of 48V and 25 AH. Alternatively, a specification of 24V and 50 AH can be achieved by linking the sixteen batteries 23 in pairs in parallel connection first, and then linking the paired batteries 23 in series connection. Alternatively, as shown in FIG. 2, in order to achieve a specification of 12V and 100 AH, the sixteen batteries 23 can be divided into four groups in each of which four batteries 23 are linked in parallel connection, and then the four groups are linked in series connection. In other words, different specifications can be achieved through different linking means of the batteries 23. Usually, a label showing one certain of specification may be marked on one of the side walls 11 of the frame 10.

Referring to FIG. 3 again, the conductive members 24 include a plurality of first and second conductive members 241 and 242. Each conductive member is made of a conductive metal and is formed or cast of one piece for carrying high current and robust heat dissipating. Each of the first and second conductive members 241 and 242 defines a plurality of through holes (not labeled) for the positive poles and the negative poles of the batteries 23 upwardly extending therethrough. The first and second conductive members 241 and 242 are mounted onto the top wall of the top bracket 21 for linking the batteries 23 in parallel connection and/or in series connection. Besides, a plurality of nuts (not labeled) is mounted to the positive poles and the negative poles for fixing the conductive members 24 and the batteries 23 together with the top bracket 21.

Referring to FIGS. 1 and 6, the battery management circuit board 41 is fixed to the top bracket 21 and electrically connecting with the batteries 23. In order to fix the battery management circuit board 41, a plurality of supporting posts 211 are employed to be fixed to the mounting posts 212 via thread connections. As a result, the battery management circuit board 41 is spatially separated from the top wall of the top bracket 21 by the supporting posts 211 and the mounting posts 212 along the vertical direction. The battery management circuit board 41 includes a battery management control module for controlling voltage, current and temperature of the batteries 23. The battery management control module includes at least one electric switch 411 and the battery management control module realizes protection of the batteries 23 via controlling connection or disconnection of the electric switch 411. According to the embodiment of the present invention, a field effect transistor (FET) is applied as the electric switch 411.

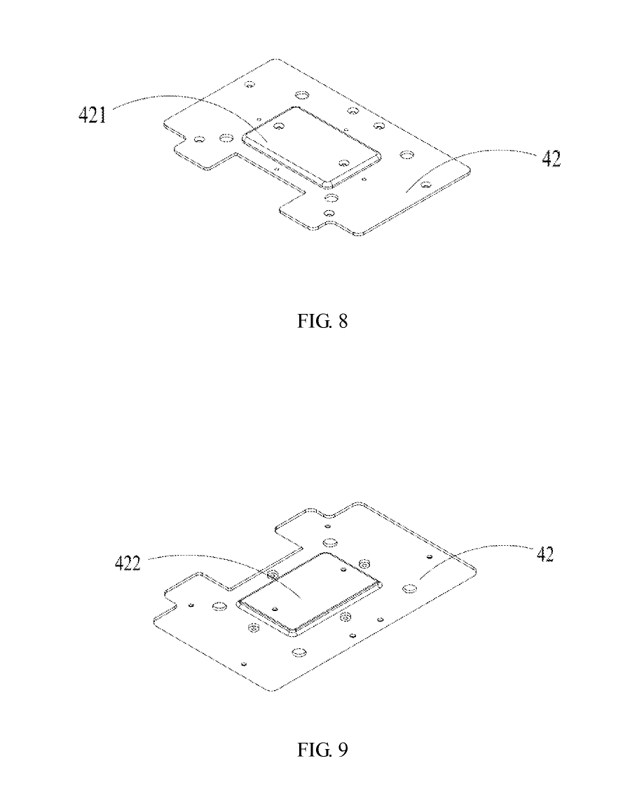

The heat sink 42 is located between the battery management circuit board 41 and the cover 30. The heat sink 42 is made of aluminum or copper for robust heat dissipation. The heat sink 42 can also be made of other materials. As shown in FIGS. 8 and 9, the heat sink 42 is stamped to form a rectangular protrusion 421 and a rectangular recessed area 422 defined in the rectangular protrusion 421 for receiving the battery balancing circuit board 43. The heat sink 42 is connected to the battery management circuit board 41 via a plurality of fixing posts 213. Each supporting post 211 is longer than each fixing post 213 along the vertical direction. The fixing posts 213 are fixed to the supporting posts 211 via thread connection so as to make sure the battery management circuit board 41 can be stably fixed between the fixing posts 213 and the supporting posts 211.

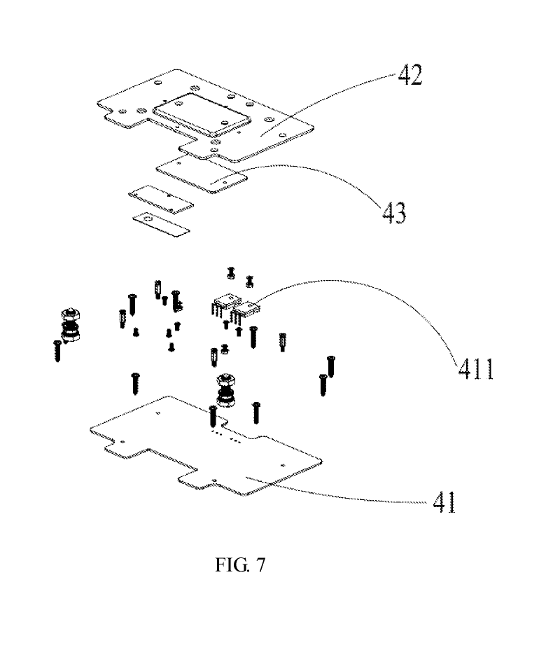

Referring to FIGS. 7-9, the battery balancing circuit board 43 is a flat printed circuit board. The battery balancing circuit board 43 is passively balanced by transforming surplus electric energy of the batteries 23 into thermal energy via its resistances. The battery balancing circuit board 43 is arranged between the battery management circuit board 41 and the heat sink 42 and is fixed to the heat sink 42. The battery balancing circuit board 43 includes a battery balancing control module for controlling surplus electric energy of the batteries 23 being dissipated into thermal energy.

As shown in FIGS. 5, 8, 10 and 11, the cover 30 is mounted to a top side of the frame 10 to prevent the internal battery module 20 from occurring electrical failure by outside influence. The cover 30 defines an opening to receive the protrusion 421 of the heat sink 42 so that the protrusion 421 is exposed for connecting with a bottom side of the cooling fins 50.

The battery system 100 in one embodiment, can be assembled by the following steps:

Step 1: placing the bottom bracket 22 of the bracket assembly into the receiving cavity of the frame 10;

Step 2: assembling the batteries 23 onto the bottom bracket 22;

Step 3: placing the top bracket 21 onto the top of the batteries 23 with the poles of the batteries 23 extending through the top wall of the top bracket 21;

Step 4: locking the supporting posts 211 onto the mounting posts 212 of the top bracket 21;

Step 5: assembling the battery management circuit board 41 onto the supporting posts 211 and using fixing posts 213 for fixation;

Step 6: retaining the battery balancing circuit board 43 in the recessed area 422 of the heat sink 42;

Step 7: locking the heat sink 42 onto the fixing posts 213 via screws;

Step 8: linking the batteries with the battery management circuit board 41 and the battery balancing circuit board 43;

Step 9: placing the cover 30 onto the frame 10 and using screws for fixation;

Step 10: locking the heat sink 42 and the cover 30 with each other; and

Step 11: locking the cooling fins 50 onto the top of the cover 30.

Referring to FIG. 7, when the battery system 100 is in operation, the battery balancing circuit board 43 is passively balanced by transforming surplus electric energy of the batteries 23 into thermal energy. In such a process, a great amount of heat is generated. Such heat can be easily dissipated by the heat sink 42 since the battery balancing circuit board 43 is directly connected to the heat sink 42. In accordance with the illustrated embodiment as shown in FIG. 7, the battery balancing circuit board 43 is fixed to the heat sink 42 by a plurality of screws. Preferably, the field effect transistor (FET) is applied as the electric switch 411. However, the FET is connected or disconnected under high frequency, thus ineluctably generating a large amount of heat, and it is important to dissipate the heat in order to protect the electric switch 411.

In order to solve this problem, the battery system 100 further includes an insulating piece located between the electric switch 411 and the heat sink 42. The insulating piece includes silicone or mica insulator. With the insulating piece, the electric switch 411 can be prevented from striking to be failure under electric leakage. Besides, a projected area of the insulating piece on the heat sink 42 is larger than that of the electric switch 411 on the heat sink 42 in order to prevent the electric switch 411 from electrically contacting the heat sink 42. In addition, heat-dissipating oil is provided between the electric switch 411 and the insulating piece, and between the insulating piece and the heat sink 42. The heat-dissipating oil includes heat-dissipating silicone. Under this condition, with the heat-dissipating oil, the heat of the electric switch 411 can be transferred to the insulating piece, and then to the heat sink 42, and ultimately to the outside via the cooling fins 50. As a result, heat generated inside the battery system 100 can be dissipated to the outside in time.

According to embodiments of the present invention, the same frame 10 can be used for configuring different specifications through different connections of the batteries 23 to improve the sharing rate of the frame 10. Moreover, with the battery management circuit board 41 mounted to and spaced from the top bracket 21, it is easy to arrange the connecting circuits and easy to open the cover 30 for repairing. Furthermore, with the battery balancing circuit board 43 set on the heat sink 42, the generated heat can be dissipated to the outside timely.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

It is to be understood, however, that even though numerous, characteristics and advantages of the present invention have been set forth in the foregoing description, together with details of the structure and function of the invention, the disclosed is illustrative only, and changes may be made in detail, especially in matters of number, shape, size, and arrangement of parts within the principles of the invention to the full extent indicated by the broadest general meaning of the terms in which the appended claims are expressed.

What is claimed is:

1. A battery system, comprising:
a battery module comprising a bracket assembly and a plurality of batteries fixed to the bracket assembly, the plurality of batteries electrically connected to each other;
a frame defining a receiving cavity for accommodating the battery module;
a cover for covering the frame; and
a battery management circuit board fixed to the bracket assembly and electrically connected to the plurality of batteries, the battery management circuit board being separated by a distance from the bracket assembly.

2. The battery system as claimed in claim 1, further comprising a supporting post located between the battery management circuit board and the bracket assembly, wherein the battery management circuit board is supported by the supporting post.

3. The battery system as claimed in claim 2, wherein the bracket assembly comprises a top bracket and a bottom bracket with the batteries clamped therebetween, the top bracket comprising a top wall and a mounting post extending from the top wall such that the mounting post is fixed to the supporting post via thread connections, and the battery management circuit board being separated from the top wall of the bracket assembly by the supporting post and the mounting post.

4. The battery system as claimed in claim 2, further comprising a heat sink located between the battery management circuit board and the cover, wherein the heat sink is connected to the battery management circuit board through a fixing post.

5. The battery system as claimed in claim 4, wherein the supporting post is longer than the fixing post.

6. The battery system as claimed in claim 4, further comprising a battery balancing circuit board located between the battery management circuit board and the heat sink, wherein the battery balancing circuit board is adapted for controlling surplus electric energy of the batteries being dissipated into thermal energy.

7. The battery system as claimed in claim 4, wherein the heat sink is made of metal and defines a recessed area for receiving the battery balancing circuit board.

8. The battery system as claimed in claim 7, wherein the heat sink is stamped to form a protrusion with the recessed area defined therein, the cover defining an opening through which the protrusion is exposed.

9. The battery system as claimed in claim 1, wherein the battery management circuit board comprises a battery management control module for surveilling voltage, current and temperature of the batteries.

10. The battery system as claimed in claim 9, wherein the battery management control module comprises an electric switch, wherein the battery management control module is adapted for protecting the batteries via controlling connection or disconnection of the electric switch.

11. A battery system, comprising:
a battery module comprising a bracket assembly and a plurality of batteries fixed to the bracket assembly, the batteries electrically connected to each other;
a frame defining a receiving cavity for accommodating the battery module;
a cover for covering the frame;
a heat sink fixed between the frame and the cover; and
a battery balancing circuit board fixed to the heat sink and comprising a battery balancing control module for controlling surplus electric energy of the batteries being dissipated into thermal energy.

12. The battery system as claimed in claim 11, further comprising a battery management circuit board comprising a battery management control module for surveilling voltage, current and temperature of the batteries.

13. The battery system as claimed in claim 12, wherein the battery management control module comprises an electric switch, wherein the battery management control module is adapted for protecting the batteries via controlling connection or disconnection of the electric switch.

14. The battery system as claimed in claim 13, wherein the electric switch comprises a field effect transistor.

15. The battery system as claimed in claim 13, further comprising an insulating piece located between the electric switch and the heat sink.

16. The battery system as claimed in claim 15, wherein a projected area of the insulating piece on the heat sink is larger than that of the electric switch on the heat sink in order to prevent the electric switch from electrically contacting the heat sink.

17. The battery system as claimed in claim 15, further comprising heat-dissipating oil filled between the electric switch and the insulating piece, and between the insulating piece and the heat sink.

18. The battery system as claimed in claim 17, wherein the insulating piece comprises silicone or mica insulator, and the heat-dissipating oil comprises heat-dissipating silicone.

19. The battery system as claimed in claim 11, wherein the heat sink is made of metal and stamped to form a protrusion with a recessed area defined therein, the battery balancing circuit board being received in the recessed area.

20. The battery system as claimed in claim 19, wherein the cover defines an opening to receive the protrusion of the heat sink, and the battery system further comprises a cooling fins covering the opening and in communication with the heat sink.
